(19) United States
(12) Patent Application Publication
(10) Pub. No.: US 2012/0118522 A1
(43) Pub. Date: May 17, 2012

(54) Aqueous Solutions Of Acid Dyes For Shading In Size Press Applications

(75) Inventor: Heidrun Grether-Schene, Efringen-Kirchen (DE)

(73) Assignee: CLARIANT FINANCE (BVI) LIMITED, Tortola (VG)

(21) Appl. No.: 13/386,526

(22) PCT Filed: Jul. 23, 2010
(86) PCT No.: PCT/EP2010/004539

§ 371 Date: Jan. 23, 2012

(30) Foreign Application Priority Data
Jul. 24, 2009 (EP) 09166386.4

(51) Int. Cl. D21H 21/16; C09D 7/12; C08K 5/3492

(52) U.S. Cl. 162/162; 524/100; 106/287.21

(57) ABSTRACT

The instant invention relates to liquid sizing compositions comprising shading dyestuffs, derivatives of diaminostibene, binders, protective polymers, and optionally divalent metal salts which can be used for the optical brightening of substrates, including substrates suitable for high quality ink jet printing.

The instant invention relates to liquid sizing compositions comprising shading dyestuffs, derivatives of diaminostilbene, binders, protective polymers, and optionally divalent metal salts which can be used for the optical brightening of substrates, including substrates suitable for high quality ink jet printing.

### BACKGROUND OF THE INVENTION

The problem of the decrease of the brightness while using shading dyes is a widely known problem.

Surprisingly, we have now discovered certain shading dyes which have a strongly positive effect on whiteness while having little or no effect on brightness, and which can be used in sizing compositions comprising optical brighteners, a protective polymer, binders, and optionally a divalent metal salt in order to enable the papermaker to reach high levels of whiteness and brightness.

Therefore, the goal of the present invention is to provide aqueous sizing compositions containing derivatives of diaminostilbene optical brightener, certain shading dyes, a protective polymer, binders, and optionally a divalent metal salt, which afford enhanced high whiteness levels while avoiding the disadvantages characterized by the use of shading dyes (loss of brightness) recognized as being state-of-the-art.

Therefore, the goal of the present invention is to provide a liquid sizing composition containing an acid dye and a derivative of diaminostilbene optical brightener affording a remarkably low loss in brightness.

Preferably the inventive process is characterized in that the liquid sizing compositions contain at least one protective polymer.

Preferably the inventive process is also characterized in that the liquid sizing compositions further contain at least one divalent metal salt.

The present invention further provides a process for surface tinting characterized in that an aqueous sizing composition containing at least one acid dye and at least one optical brightener is used.

### DESCRIPTION OF THE INVENTION

The present invention therefore provides aqueous sizing compositions for optical brightening of substrates, preferably paper, comprising
(a) 0.0001 to 0.005% by weight of an acid dye of formula (1)

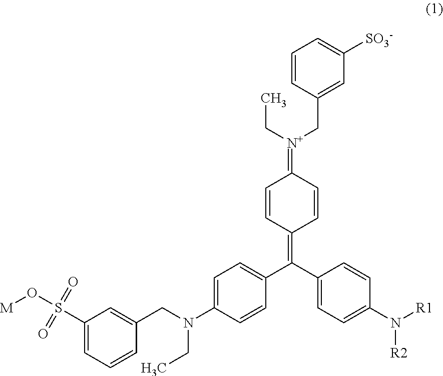

wherein
R1 signifies H, methyl or ethyl,
R2 signifies paramethoxyphenyl, methyl or ethyl,
M signifies an alkali metal kation
(b) between 0.000002 to 0.0027% by weight of at least one protective polymer selected from
   (i) a polyvinyl alcohol or a carboxylic acid containing polyvinyl alcohol;
   (ii) a homopolymer of acrylamide, acrylic acid or methacrylic acid;
   (iii) a copolymer of acrylic acid or methacrylic acid with acrylamide or methacrylamide.
   (iv) a polyethylene glycol;
(c) between 0.01 and 2% by weight of at least one optical brightener of formula (2);

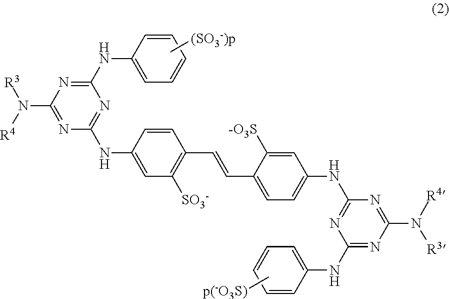

in which
the anionic charge on the brightener is balanced by a cationic charge composed of one or more identical or different cations selected from the group consisting of hydrogen, an alkali metal cation, alkaline earth metal, ammonium, ammonium which is mono-, di- or trisubstituted by a C1-C4 linear or branched alkyl radical, ammonium which is mono-, di- or trisubstituted by a C1-C4 linear or branched hydroxyalkyl radical, or mixtures of said compounds,
R³ and R^{3′} may be the same or different, and each is hydrogen, C1-C4 linear or branched alkyl, C2-C4 linear or branched hydroxyalkyl, CH₂CO₂⁻, CH₂CH₂CONH₂ or CH₂CH₂CN,
R⁴ and R^{4′} may be the same or different, and each is C1-C4 linear or branched alkyl, C2-C4 linear or branched hydroxyalkyl, CH₂CO₂⁻, CH(CO₂⁻)CH₂CO₂⁻, CH(CO₂⁻)CH₂CH₂CO₂⁻, CH₂CH₂SO₃⁻, benzyl, or
R³ and R⁴ and/or R^{3′} and R^{4′}, together with the neighboring nitrogen atom signify a morpholine ring and
p is 0, 1 or 2.
(d) between 1 and 30% by weight of at least one binder;
(e) optionally, between 0.1 and 10% by weight of at least one divalent metal salt;
(f) optionally a biozide and
(g) the remainder up to 100% by weight water.

This composition comprising the components (a) and (b) and (c) and (d) and (e) and (f) and (g) is preferably used to size paper in the size press. Therefore the composition comprising the components (a) and (b) and (c) and (d) and (e) and (f) and (g) is an aqueous sizing composition used in the production of coated paper.

In optical brighteners for which p is 1, the SO₃⁻ group is preferably in the 4-position of the phenyl group.

In optical brighteners for which p is 2, the SO₃⁻ groups are preferably in the 2,5-positions of the phenyl group.

Preferred compounds of formula (2) are those in which the anionic charge on the brightener is balanced by a cationic charge composed of one or more identical or different cations selected from the group consisting of hydrogen, an alkali metal cation, alkaline earth metal, ammonium which is mono-, di- or trisubstituted by a C1-C4 linear or branched hydroxyalkyl radical, or mixtures of said compounds,
R³ and R^{3′} may be the same or different, and each is hydrogen, C1-C4 linear or branched alkyl, C2-C4 linear or branched hydroxyalkyl, CH₂CO₂⁻, CH₂CH₂CONH₂ or CH₂CH₂CN,
R⁴ and R^{4′} may be the same or different, and each is C1-C4 linear or branched alkyl, C2-C4 linear or branched hydroxyalkyl, CH₂CO₂⁻, CH(CO₂⁻)CH₂CO₂⁻ or CH(CO₂⁻)CH₂CH₂CO₂⁻ and
p is 0, 1 or 2.

More preferred compounds of formula (2) are those in which
the anionic charge on the brightener is balanced by a cationic charge composed of one or more identical or different cations selected from the group consisting of Li, Na, K, Ca, Mg, ammonium which is mono-, di- or trisubstituted by a C1-C4 linear or branched hydroxyalkyl radical, or mixtures of said compounds,
   R³ and R^{3′} may be the same or different, and each is hydrogen, methyl, ethyl, α-methylpropyl, β-methylpropyl, β-hydroxyethyl, β-hydroxypropyl, CH₂CO₂⁻, CH₂CH₂CONH₂ or CH₂CH₂CN,
   R⁴ and R^{4′} may be the same or different, and each is methyl, ethyl, α-methylpropyl, β-methylpropyl, 3-hydroxyethyl, β-hydroxypropyl, CH₂CO₂⁻ or
      CH(CO₂⁻)CH₂CO₂⁻, and
   p is 0, 1 or 2.

Especially preferred compounds of formula (2) are those in which
the anionic charge on the brightener is balanced by a cationic charge composed of one or more identical or different cations selected from the group consisting of Na, K and triethanolamine or mixtures of said compounds,
   R³ and R^{3′} may be the same or different, and each is hydrogen, ethyl, β-hydroxyethyl, β-hydroxypropyl, CH₂CO₂⁻, or CH₂CH₂CN,
   R⁴ and R^{4′} may be the same or different, and each is ethyl, β-hydroxyethyl, β-hydroxypropyl, CH₂CO₂⁻ or CH(CO₂⁻)CH₂CO₂⁻, and
   p is 2.

The binder is selected from the group consisting of native starch, enzymatically modified starch and chemically modified starch. Modified starches are preferably oxidized starch, hydroxyethylated starch or acetylated starch. The native starch is preferably an anionic starch, a cationic starch, or an amphoteric starch. While the starch source may be any, preferably the starch sources are corn, wheat, potato, rice, tapioca or sago.

The concentration of binder in the sizing composition may be between 1 and 30% by weight, preferably between 2 and 20% by weight, most preferably between 5 and 15% by weight.

Preferred divalent metal salts are selected from the group consisting of calcium chloride, magnesium chloride, calcium bromide, magnesium bromide, calcium iodide, magnesium iodide, calcium nitrate, magnesium nitrate, calcium formate, magnesium formate, calcium acetate, magnesium acetate, calcium citrate, magnesium citrate, calcium gluconate, magnesium gluconate, calcium ascorbate, magnesium ascorbate, calcium sulfite, magnesium sulfite, calcium bisulfite, magnesium bisulfite, calcium dithionite, magnesium dithionite, calcium sulphate, magnesium sulphate, calcium thiosulphate, magnesium thiosulphate or mixtures of said compounds.

More preferred divalent metal salts are selected from the group consisting of calcium chloride, magnesium chloride, calcium bromide, magnesium bromide, calcium sulphate, magnesium sulphate, calcium thiosulphate or magnesium thiosulphate or mixtures of said compounds.

Especially preferred divalent metal salts are selected from the group consisting of calcium chloride or magnesium chloride or mixtures of said compounds.

When the sizing composition contains a divalent metal salt, the concentration of divalent metal salt in the sizing composition may be between 1 and 100 g/l, preferably between 2 and 75 g/l, most preferably between 5 and 50 g/l.

When the divalent metal salt is a mixture of one or more calcium salts and one or more magnesium salts, the amount of calcium salts may be in the range of 0.1 to 99.9%.

The polyethylene glycol which may be employed as component (b) has an average molecular weight in the range of 100 to 8000, preferably in the range of 200 to 6000, most preferably in the range of 300 to 4500. When used as component (b), the content in the dyestuff solution may be between 0.1 and 10%, preferably between 0.1 and 7%, most preferably between 0.4 and 6%.

The polyvinyl alcohol which may be employed as component (b) has a degree of hydrolysis greater than or equal to 60% and a Brookfield viscosity of between 2 and 40 mPa·s for a 4% aqueous solution at 20° C. Preferably the degree of hydrolysis is between 69% and 95%, and the Brookfield viscosity is between 2 and 20 mPa·s (4% aqueous solution at 20° C.). Most preferably, the degree of hydrolysis is between 69% and 90%, and the Brookfield viscosity is between 2 and 20 mPa·s (4% aqueous solution at 20° C.). When used as component (b), the content in the dyestuff solution may be between 0.1 and 6%, preferably between 0.1 and 5%, most preferably between 0.2 and 5%.

The carboxylic acid containing polyvinyl alcohol which may be employed as component (b) has a degree of hydrolysis greater than or equal to 60% and a Brookfield viscosity of between 2 and 40 mPa·s for a 4% aqueous solution at 20° C. Preferably the degree of hydrolysis is between 70% and 95%, and the Brookfield viscosity is between 2 and 35 mPa·s (4% aqueous solution at 20° C.). Most preferably, the degree of hydrolysis is between 70% and 90%, and the Brookfield viscosity is between 2 and 30 mPa·s (4% aqueous solution at 20° C.).

When used as component (b), the content in the dyestuff solution may be between 0.1 and 6%, preferably between 0.1 and 5%, most preferably between 0.2 and 5%.

The polymer of acrylamide which may be employed as component (b) has a Brookfield viscosity of between 100 and 40000 mPa·s for a 0.5-20% aqueous solution at 20-25° C. Preferably the viscosity is between 100 and 30000 mPa·s (0.5-20% aqueous solution at 20-25° C.). Most preferably, the viscosity is between 100 and 10000 mPa·s (0.5-20% aqueous solution at 20-25° C.). When used as component (b), the content in the dyestuff solution may be between 0.05 and 3%, preferably between 0.05 and 2%, most preferably between 0.05 and 1.5%.

The polymer of acrylic acid or methacrylic acid which may be employed as component (b) has a Brookfield viscosity of between 100 and 40000 mPa·s for a 7-8% aqueous solution at 20° C. The polymer can be optionally used in its partial or full salt form. The preferred salt is Na, K, Ca, Mg, ammonium or ammonium which is mono-, di- or tri-substituted by a linear or branched alkyl or hydroxyalkyl radical. Preferably the viscosity is between 1000 and 30000 mPa·s (7-8% aqueous solution at 20° C.). Most preferably, the viscosity is between 5000 and 20000 mPa·s (7-8% aqueous solution at 20° C.). When used as component (b), the content in the dyestuff solution may be between 0.1 and 6%, preferably between 0.1 and 5%, most preferably between 0.2 and 5%.

The copolymer of acrylic acid and acrylamide which may be employed as component (b) has a Brookfield viscosity of between 1 and 100 mPa·s for a 0.1 aqueous solution at 20° C. The copolymer can be either a block or a cross-linked copolymer. The copolymer can be optionally used in its partial or full salt form. The preferred salt is Na, K, Ca, Mg, ammonium or ammonium which is mono-, di- or tri-substituted by a linear or branched alkyl or hydroxyalkyl radical. Preferably the viscosity is between 1 and 80 mPa·s (0.1% aqueous solution at 20° C.). Most preferably, the viscosity is between 1 and 50 mPa·s (0.1% aqueous solution at 20° C.). When used as component (b), the content in the dyestuff solution may be between 0.1 and 6%, preferably between 0.1 and 5%, most preferably between 0.2 and 5%.

The copolymer of methacrylic acid and methacrylamide which may be employed as component (b) has a Brookfield viscosity of between 1 and 100000 mPa·s for an 8% aqueous solution at 20° C. The copolymer can be either a block or a cross-linked copolymer. The copolymer can be optionally used in its partial or full salt form. The preferred salt is Na, K, Ca, Mg, ammonium or ammonium which is mono-, di- or tri-substituted by a linear or branched alkyl or hydroxyalkyl radical. Preferably the viscosity is between 10000 and 80000 mPa·s (8% aqueous solution at 20° C.). Most preferably, the viscosity is between 40000 and 50000 mPa·s (8% aqueous solution at 20° C.). When used as component (b), the content in the dyestuff solution may be between 0.1 and 6%, preferably between 0.1 and 5%, most preferably between 0.2 and 4%.

The pH value of the sizing composition is typically in the range of 5-13, preferably 6-11.

The sizing composition may additionally contain by-products formed during the preparation of the optical brightener as well as other conventional paper additives. Examples of such additives are antifreezes, biocides, defoamers, wax emulsions, inorganic salts, solubilizing aids, preservatives, complexing agents, thickeners, surface sizing agents, cross-linkers, pigments, special resins etc.

The sizing composition is prepared by adding the optical brightener, the shading dye, the protective polymer and optionally the divalent metal salt to a preformed aqueous solution of the binder at a temperature between 20° C. and 90° C.

The sizing composition is prepared by adding the solution of the shading dye containing the protective polymer, the optical brightener and optionally the divalent metal salt to a preformed aqueous solution of the binder at a temperature between 20° C. and 90° C.

Alternatively the single components may be added individually and then mixed. However, in many cases it might be favorable to produce stock solutions from the Acid Dye and the protective polymer and mix this stock solution with the further ingredients.

The sizing composition may be applied to the surface of a paper substrate by any surface treatment method known in the art. Examples of application methods include size-press applications, calendar size application, tub sizing, coating applications and spraying applications. (See, for example, pages 283-286 in Handbook for Pulp & Paper Technologists by G. A. Smook, 2^{nd} Edition Angus Wilde Publications, 1992 and US 2007/0277950.) The preferred method of application is at the size-press such as puddle size press. A preformed sheet of paper is passed through a two-roll nip which is flooded with the sizing composition.

The paper absorbs some of the composition, the remainder being removed in the nip.

The paper substrate contains a web of cellulose fibres which may be sourced from any fibrous plant. Preferably the cellulose fibres are sourced from hardwood and/or softwood. The fibres may be either virgin fibres or recycled fibres, or any combination of virgin and recycled fibres.

The cellulose fibres contained in the paper substrate may be modified by physical and/or chemical methods as described, for example, in Chapters 13 and 15 respectively in Handbook for Pulp & Paper Technologists by G. A. Smook, 2^{nd} Edition Angus Wilde Publications, 1992. One example of a chemical modification of the cellulose fibre is the addition of an optical brightener as described, for example, in EP 884,312, EP 899,373, WO 02/055646, WO 2006/061399 and WO 2007/017336.

One example of an especially preferred optical brightener of formula (2) is described by formula (3). Preparative methods for synthesizing optical brightener of formula (3) are well-known.

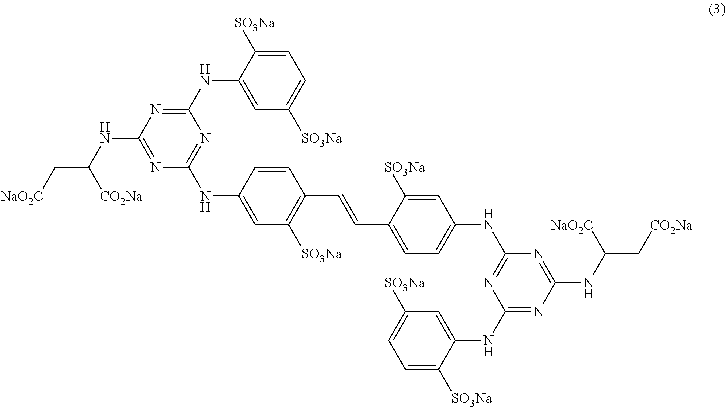

### EXAMPLES

The following examples shall demonstrate the instant invention in more details. In the present application, if not indicated otherwise, “parts” means “parts by weight”, “%” means “% by weight” and viscosities are measured using a Brookfield viscosimeter at 20° C., using spindle No 18, according to DIN 53214. The viscosities of the polyvinyl alcohols are measured by a Höppler viscosimeter according to DIN 53015.

To the dyestuff solutions can be added optionally a biocide for example Proxel™ GXL (Proxel is a trade mark of Zeneca AG Products, Inc. and comprises 1,2-benzisothiazolin-3-one (CAS No.: 2634-33-5)).

The order in which the single parts of the following solutions or sizing compositions are added are outlined below but are not limited to those mentioned. However, the order of addition is generally not critical.

### Preparative Example 1

Into 567 g warm water of 50-60° C. are added under stirring within 60 minutes 73.4 g Acid Violet 49 (95% material). Agitation is continued for a further hour at 60° C. while a solution forms. The dyestuff solution is then clarified by the use of a filtering aid. Afterwards 2.8 g of a polyvinyl alcohol, having a degree of hydrolysis of 69.5-72.5% and a Brookfield viscosity of 5-5.8 mPa·s, are dissolved in approx. 104 ml of deionised water of 80-90° C. by stirring one hour at this temperature. After cooling this pale yellow solution to room temperature it is poured into the dyestuff solution. Further deionised water is added to receive 711.5 g dyestuff solution. After cooling to room temperature the solution remains stable and the pH is in the range of 6.5-7.5.

A sample of the solution thus obtained was stable even after two weeks of storage at 0° C. and thawing in that it neither separated nor developed streaks. Similarly, the sample stored for two weeks at 50° C. and cooled down to room temperature was observed neither to separate nor to develop streaks.

### Preparative Example 2

A dyestuff solution is obtained following the same procedure as in example 1 with the sole differences that 14.2 g of a polyvinyl alcohol are used having a degree of hydrolysis of 69.5-72.5% and a Brookfield viscosity of 5-5.8 mPa·s. The pH of the solution is in the range of 6.5-7.0.

### Preparative Example 3

A dyestuff solution is obtained following the same procedure as in example 1 with the sole differences that 2.8 g of a polyvinyl alcohol are used having a degree of hydrolysis of approx. 88% and a Brookfield viscosity of 7.0-9.0 mPa·s. The pH of the solution is in the range of 6.5-7.5.

### Preparative Example 4

Into 567 g warm water of 50-60° C. are added under stirring within 60 minutes 73.4 g Acid Violet 49 (95% material). Agitation is continued for further 30 minutes at 60° C. while a solution forms. Afterwards 3.6 g of a polyvinyl alcohol are added having a degree of hydrolysis of approx. 85% and a Brookfield viscosity of 3.4-4.0 mPa·s. The mixture is stirred for another 30 minutes at 60° C. and diluted with deionised water to receive 711.5 g solution. After cooling to room temperature the solution remains stable and the pH is in the range of 6.5-7.5.

### Preparative Example 5

A dyestuff solution is obtained following the same procedure as in example 1 with the sole differences that 3.6 g of a polyacrylamide in form of 109.1 g of a 3.3% aqueous solution are used. A clear 3.3% aqueous solution of this polyacrylamide has a Brookfield viscosity of 105 mPa·s at 20° C.

The pH of the dyestuff solution is in the range of 6.5-7.0.

### Preparative Example 6

A dyestuff solution is obtained following the same procedure as in example 4 with the sole differences that 3.6 g of a polyacrylamide in form of 18 g of a 20% aqueous solution are used. The clear 20% aqueous solution of this polyacrylamide has a Brookfield viscosity of 500-1000 mPa·s at 25° C. The pH of the dyestuff solution is in the range of 6.5-7.0.

### Preparative Example 7

A dyestuff solution is obtained following the same procedure as in example 4 with the sole differences that 3.6 g of a polyacrylamide are used. The clear 0.5% aqueous solution of this polyacrylamide has a Brookfield viscosity of 120 mPa·s at 25° C.

The pH of the dyestuff solution is in the range of 6.0-6.5.

### Preparative Example 8

A dyestuff solution is obtained following the same procedure as in example 4 with the sole differences that 3.6 g of a polyacrylamide are used. The clear 0.5% aqueous solution of this polyacrylamide has a Brookfield viscosity of approx. 240 mPa·s at 25° C.

The pH of the dyestuff solution is in the range of 6.0-6.5.

### Preparative Example 9

A dyestuff solution is obtained following the same procedure as in example 4 with the sole differences that 3.6 g of a polyacrylamide are used and dissolved at 80° C. The clear 10% aqueous solution of this polyacrylamide has a Brookfield viscosity of approx. 320 mPa·s at 25° C.

The pH of the dyestuff solution is approx. 6.5.

### Preparative Example 10

Into 567 g warm water of 50-60° C. are added under stirring within 60 minutes 36.7 g Acid Violet 49 (95% material). Agitation is continued for a further hour at 60° C. while a solution forms. The dyestuff solution is then clarified by the use of a filtering aid. Afterwards 3.6 g of a polyacrylamide in form of 109.1 g of a 3.3% aqueous solution are dosed in. Further deionised water is added to receive 711.5 g dyestuff solution. After cooling down to room temperature the solution remains stable and the pH is in the range of 6.0-6.5. A clear 3.3% aqueous solution of this polyacrylamide has a Brookfield viscosity of 105 mPa·s at 20° C.

### Preparative Example 11

A dyestuff solution is obtained following the same procedure as in example 10 with the sole differences that 35.6 g of a polyethylene glycol having an average molecular weight of 1500 are used.

The pH of the dyestuff solution is approx. 6.0.

### Preparative Example 12

A dyestuff solution is obtained following the same procedure as in example 10 with the sole differences that 3.6 g of a poly(acrylamide-co-acrylic acid) having a Brookfield viscosity between 2 and 3 mPa·s for a 0.1% aqueous solution at 20° C. are used.

The pH of the dyestuff solution is in the range of 6.0-6.5.

### Preparative Example 13

A dyestuff solution is obtained following the same procedure as in example 10 with the sole differences that 17.8 g of a carboxylic acid containing polyvinyl alcohol having a degree of hydrolysis between 85% and 90% and a Brookfield viscosity between 20 and 30 mPa·s for a 4% aqueous solution at 20° C. are used.

The pH of the dyestuff solution is approx. 6.0.

### Preparative Example 14

Preparation of poly(methacrylamide-co-methacrylic acid): 0.15 parts of radical initiator Vazo68 are mixed with 43.25 parts of methacrylic acid, 43.18 parts of methacrylamide and 1000 parts of demineralized water. The mixture is stirred and heated under nitrogen to 74-76° C. over a period of 1 hour. After 10 minutes at 74-76° C., stirring is stopped and the mixture is left 16 hours at 74-76° C. 45.6 parts of aqueous sodium hydroxide (33%) are added, stirring is re-started and the temperature is allowed to fall to room temperature. The pH of the final product is approx. 7.0-8.0 and the viscosity is approx. 40000-50000 mPa·s at 20° C.

The aqueous solution so-formed (1132 parts) contains approx. 90 parts of poly(methacrylamide-co-methacrylic acid) as its sodium salt.

### Preparative Example 15

A dyestuff solution is obtained following the same procedure as in example 10 with the sole differences that 7.1 g of the poly(methacrylamide-co-methacrylic acid) in form 88.9 g of an aqueous solution prepared according to preparative example 14. The pH of the dyestuff solution is in the range of 6.5-7.0.

### Preparative Example 16

Into 567 g warm water of 50-60° C. are added under stirring within 60 minutes 73.4 g Acid Violet 17 (95% material). Agitation is continued for further 30 minutes at 60° C. while a solution forms. The dyestuff solution is then clarified by the use of a filtering aid. Afterwards 2.8 g of a polyvinyl alcohol are added having a degree of hydrolysis of 69.5-72.5% and a Brookfield viscosity of 5-5.8 mPa·s. The mixture is heated up to 80° C., stirred for another 60 minutes at this temperature and diluted with deionised water to receive 711.5 g solution. After cooling to room temperature the solution remains stable and the pH is in the range of 6.5-7.5.

### Preparative Example 17

A dyestuff solution is obtained following the same procedure as in example 16 with the sole differences that 14.2 g of a polyvinyl alcohol are used having a degree of hydrolysis of 69.5-72.5% and a Brookfield viscosity of 5-5.8 mPa·s. The pH of the solution is in the range of 6.5-7.0.

### Preparative Example 18

A dyestuff solution is obtained following the same procedure as in example 16 with the sole differences that 2.8 g of a polyvinyl alcohol are used having a degree of hydrolysis of approx. 88% and a Brookfield viscosity of 7.0-9.0 mPa·s. The pH of the solution is in the range of 6.5-7.5.

### Preparative Example 19

A dyestuff solution is obtained following the same procedure as in example 16 with the sole differences that 3.6 g of a polyacrylamide are used. The clear 0.5% aqueous solution of this polyacrylamide has a Brookfield viscosity of approx. 240 mPa·s at 25° C.

The pH of the dyestuff solution is in the range of 6.0-6.5.

### Preparative Example 20

A dyestuff solution is obtained following the same procedure as in example 16 with the sole differences that 3.6 g of a polyacrylamide are used and dissolved at 80° C. The clear 10% aqueous solution of this polyacrylamide has a Brookfield viscosity of 320 mPa·s at 25° C.

The pH of the dyestuff solution is approx. 6.5.

### Comparative example 1

A dyestuff solution is obtained following the same procedure as in Example 1 with the sole differences that no protective polymer is added. The pH of the dyestuff solution is approx. 7.0.

### Comparative Example 2

A dyestuff solution is obtained following the same procedure as in Example 10 with the sole differences that no protective polymer is added. The pH of the dyestuff solution is approx. 7.0.

### Comparative Example 3

A dyestuff solution is obtained following the same procedure as in Example 16 with the sole differences that no protective polymer is added. The pH of the dyestuff solution is approx. 7.0.

### Application Example 1 with CaCl₂

The dyestuff solution prepared according to preparative example 4 is diluted to a concentration of 0.01%.

A sizing composition is prepared by adding the diluted dyestuff solution at a range of concentrations from 0 to 0.03 g/l to a stirred, aqueous solution of calcium chloride (35 g/l), optical brightener of formula 3 (40 g/l) of a 18.2% stock solution and an anionic starch (100 g/l) (Penford Starch 260) at 60° C. The sizing solution is allowed to cool, then poured between the moving rollers of a laboratory size-press and applied to a commercial 75 g/m² AKD (alkyl ketene dimer) sized, bleached paper base sheet. The treated paper is dried for 5 minutes at 70° C. in a flat bed drier.

The dried paper is allowed to condition, and then measured for CIE whiteness and brightness on a calibrated Auto Elrepho spectrophotometer. The results are shown in Table 1-2.

The light fastness is measured on Minolta CM-3700d spectrophotometer and the results are shown in Table 3.

### Comparative Application Example 1 with Cacl₂

The dyestuff solution prepared according to comparative example 2 is diluted to a concentration of 0.01%.

A sizing composition is prepared by adding the diluted dyestuff solution at a range of concentrations from 0 to 0.03 g/l to a stirred, aqueous solution of calcium chloride (35 g/l), optical brightener of formula 3 (40 g/l) of a 18.2% stock solution and an anionic starch (100 g/l) (Penford Starch 260) at 60° C. The sizing solution is allowed to cool, then poured between the moving rollers of a laboratory size-press and applied to a commercial 75 g/m² AKD (alkyl ketene dimer) sized, bleached paper base sheet. The treated paper is dried for 5 minutes at 70° C. in a flat bed drier.

The dried paper is allowed to condition, and then measured for CIE whiteness and brightness on a calibrated Auto Elrepho spectrophotometer. The results are shown in Table 1-2.

The light fastness is measured on Minolta CM-3700d spectrophotometer and the results are shown in Table 3 and 4.

### Application Example 2 with CaCl₂

The dyestuff solutions prepared according to preparative examples 10-13 and 15 are diluted to a concentration of 0.01%.

Sizing compositions are prepared by adding this diluted aqueous solutions at a range of concentrations from 0 to 0.03 g/l to a stirred, aqueous solution of anionic starch (100 g/l) (Penford Starch 260) at 60° C. containing calcium chloride (35 g/l) and an optical brightener of formula 3 (40 g/l) of a 18.2% stock solution. The sizing solution is allowed to cool, then poured between the moving rollers of a laboratory size-press and applied to a commercial 75 g/m² AKD (alkyl ketene dimer) sized, bleached paper base sheet. The treated paper is dried for 5 minutes at 70° C. in a flat bed drier.

The dried paper is allowed to condition, and then the light fastness is measured on Minolta CM-3700d spectrophotometer and the results are shown in Table 4.

### Application Example 3 with Cacl₂

The dyestuff solutions prepared according to preparative examples 1-3 and 5-9 and comparative example 1 are diluted to a concentration of 0.01%.

Sizing compositions are prepared by adding this diluted aqueous solutions at a range of concentrations from 0 to 0.03 g/l to a stirred, aqueous solution of calcium chloride (35 g/l), optical brightener of formula 3 (40 g/l) of a 18.2% stock solution and an anionic starch (100 g/l) (Penford Starch 260) at 60° C. The sizing solution is allowed to cool, then poured between the moving rollers of a laboratory size-press and applied to a commercial 75 g/m² AKD (alkyl ketene dimer) sized, bleached paper base sheet. The treated paper is dried for 5 minutes at 70° C. in a flat bed drier.

The dried paper is allowed to condition, and then measured for CIE whiteness and brightness on a calibrated Auto Elrepho spectrophotometer. The results are shown in Table 5-6.

The light fastness is measured on Minolta CM-3700d spectrophotometer and the results are shown in Table 7.

### Application Example 4 without CaCl₂

The dyestuff solutions prepared according to preparative examples 2, 7, 9 and comparative example 1 are diluted to a concentration of 0.01%.

Sizing compositions are prepared by adding this diluted aqueous solutions at a range of concentrations from 0 to 0.03 g/l to a stirred, aqueous solution of anionic starch (100 g/l) (Penford Starch 260) at 60° C. containing an optical brightener of formula 3 (40 g/l) of a 18.2% stock solution. The sizing solution is allowed to cool, then poured between the moving rollers of a laboratory size-press and applied to a commercial 75 g/m² AKD (alkyl ketene dimer) sized, bleached paper base sheet. The treated paper is dried for 5 minutes at 70° C. in a flat bed drier.

The dried paper is allowed to condition and the light fastness is measured on Minolta CM-3700d spectrophotometer. The results are shown in Table 8.

### Application Example 5 with CaCl₂

The dyestuff solutions prepared according to preparative examples 16-20 and comparative example 3 are diluted to a concentration of 0.01%.

The sizing composition and the application on paper are made according to application example 2. The dried paper is allowed to condition, and then measured for CIE whiteness and brightness on a calibrated Auto Elrepho spectrophotometer. The results are shown in Table 9-10.

### Application Example 6 without CaCl₂

The dyestuff solutions prepared according to preparative examples 17, 18 and comparative example 3 are diluted to a concentration of 0.01%.

Sizing compositions are prepared by adding this diluted aqueous solutions at a range of concentrations from 0 to 0.03 g/l to a stirred, aqueous solution of anionic starch (100 g/l) (Penford Starch 260) at 60° C. containing an optical brightener of formula 3 (40 g/l) of a 18.2% stock solution. The sizing solution is allowed to cool, then poured between the moving rollers of a laboratory size-press and applied to a commercial 75 g/m² AKD (alkyl ketene dimer) sized, bleached paper base sheet. The treated paper is dried for 5 minutes at 70° C. in a flat bed drier.

The dried paper is allowed to condition, and then measured for the light fastness on Minolta CM-3700d spectrophotometer and the results are shown in Table 11.

### Application Example 7 with CaCl₂, UV OFF

The dyestuff solutions prepared according to preparative examples 16-20 and comparative example 3 are diluted to a concentration of 0.01%.

Sizing compositions are prepared by adding the diluted dyestuff solutions at a range of concentrations from 0 to 0.03 g/l to a stirred, aqueous solution of anionic starch (100 g/l) (Penford Starch 260) at 60° C. containing calcium chloride (35 g/l).

The sizing solution is allowed to cool, then poured between the moving rollers of a laboratory size-press and applied to a commercial 75 g/m² AKD (alkyl ketene dimer) sized, bleached paper base sheet. The treated paper is dried for 5 minutes at 70° C. in a flat bed drier.

The dried paper is allowed to condition, and then measured for CIE whiteness and brightness on a calibrated Auto Elrepho spectrophotometer. The results are shown in Table 12-13.

TABLE 1
Development of whiteness with increasing amounts of dyestuff in the
presence of CaCl₂

| | Dye [g/l] | | | | | |
|---|---|---|---|---|---|---|
| | 0 | 0.0025 | 0.005 | 0.01 | 0.02 | 0.03 |
| Direct Violet | 132.43 | 132.52 | 132.89 | 133.43 | 135.88 | 136.62 |
| 35 | | | | | | |
| Prep. | 132.43 | 134.51 | 135.96 | 138.29 | 141.73 | 145.54 |
| example 4 | | | | | | |
| Comp. | 132.43 | 134.16 | 136.34 | 138 | 141.46 | — |
| example 2 | | | | | | |

The results clearly show that the instant invention (Acid Violet 49 solutions, with and without polymer) provides a higher level of whiteness than Direct Violet 35 representing the state-of-the-art (Table 1).

TABLE 2
Development of brightness with increasing amounts of dyestuff in the
presence of CaCl₂

| | Dye [g/l] | | | | | |
|---|---|---|---|---|---|---|
| | 0 | 0.0025 | 0.005 | 0.01 | 0.02 | 0.03 |
| Direct Violet | 105.25 | 103.99 | 103.82 | 103.51 | 102.74 | 101.56 |
| 35 | | | | | | |
| Prep. | 105.25 | 105.37 | 105.33 | 105.31 | 104.81 | 104.53 |
| example 4 | | | | | | |
| Comp. | 105.25 | 105.34 | 105.43 | 105.11 | 104.88 | — |
| example 2 | | | | | | |

The results clearly show that the instant invention leads to a remarkably lower loss of brightness than Direct Violet 35 representing the state-of-the-art. At the highest addition level of shading dye (Prep. ex. 4) the loss in brightness is only 0.7% compared with 3.5% when using Direct Violet 35 (Table 2).

TABLE 3
Lightfastness with increasing time of illumination in the presence of CaCl₂

| | hours of exposure | | | | | |
|---|---|---|---|---|---|---|
| | 0 | 0.5 | 1 | 2 | 5 | 10 |
| Direct Violet 35 | 0 | −4.6 | −6.9 | −8.8 | −12.3 | −14 |
| Prep. example 4 | 0 | −4.4 | −6.8 | −8.4 | −12.1 | −11.9 |
| Comp. example 2 | 0 | −9.6 | −11.5 | −14.2 | −16.8 | −18.7 |

Paper shaded in the size press with an Acid Violet 49 solution containing the poly vinyl alcohol described in the Preparative example 4 leads to a better light fastness than the Comparative example 2 where no protective polymer is used (Table 3).

TABLE 4
Lightfastness with increasing time of illumination in the presence of CaCl₂

| | hours of exposure | | | | | |
|---|---|---|---|---|---|---|
| | 0 | 0.5 | 1 | 2 | 5 | 10 |
| Direct Violet 35 | 0 | −0.6 | −1.7 | −4.8 | −8.7 | −10.6 |
| Prep. example 11 | 0 | −2 | −4.6 | −8 | −10.6 | −12.2 |
| Prep. example 10 | 0 | −1.3 | −3.6 | −7.1 | −9.5 | −11.6 |
| Prep. example 12 | 0 | −3.3 | −7.1 | −9.2 | −13.2 | −16.7 |
| Prep. example13 | 0 | −4 | −5.5 | −8.7 | −13.5 | −17.5 |
| Prep. example 15 | 0 | −5.4 | −7.3 | −10.4 | −14 | −17.7 |
| Comp. example 2 | 0 | −6.1 | −8.9 | −13.5 | −15 | −18.3 |

Paper shaded in the size press with Acid Violet 49 solutions containing different protective polymers synthesized according to the Preparative examples 10-13 and 15 lead to a better light fastness than the Comparative example 2 without a protective polymer (Table 4). Best results are obtained with polyethylene glycol having an average molecular weight of 1500 (Prep. example 11) and the polyacrylamide described in the Prep. example 10.

TABLE 5
AV 49; Development of whiteness with increasing amounts of dyestuff in
the presence of CaCl₂

| | Dye [g/l] | | | | | |
|---|---|---|---|---|---|---|
| | 0 | 0.005 | 0.01 | 0.015 | 0.02 | 0.03 |
| DV 35 | 133.6 | 134.97 | 135.18 | 136.1 | 137.1 | 138.95 |
| Prep. ex. 1 | 133.6 | 135.4 | 137.57 | 139.03 | 140.4 | 144.2 |
| Prep. ex. 2 | 133.6 | 135.19 | 138.17 | 139.81 | 141.09 | 145.65 |
| Prep. ex. 3 | 133.6 | 135.5 | 137.34 | 139.54 | 141.2 | 146.66 |
| Prep. ex. 5 | 133.6 | 136.39 | 138.58 | 140.01 | 142.44 | 146.01 |
| Prep. ex. 6 | 133.6 | 136.59 | 138.83 | 140.04 | 141.13 | 145.69 |
| Prep. ex. 7 | 133.6 | 136.34 | 138.04 | 139.37 | 140.75 | 144.76 |
| Prep. ex. 8 | 133.6 | 136.46 | 138.9 | 140.03 | 142.4 | 146.31 |
| Prep. ex. 9 | 133.6 | 135.83 | 137.35 | 139.66 | 141.77 | 145.19 |
| Comp. ex. 1 | 133.6 | 135.46 | 137.2 | 139.7 | 142.4 | 144.95 |

With Acid Violet 49 solutions (with and without polymer) the whiteness degree is built up better than with Direct Violet 35 (Table 5). Best results are obtained with polyvinylalcohol described in Prep. example 3 and the polyacrylamides described in Prep. examples 8 and 5.

TABLE 6
AV 49; Development of brightness with increasing amounts of dyestuff in
the presence of CaCl₂

| | Dye [g/l] | | | | | |
|---|---|---|---|---|---|---|
| | 0 | 0.005 | 0.01 | 0.015 | 0.02 | 0.03 |
| DV 35 | 105.198 | 104.829 | 104.15 | 103.747 | 103.176 | 102.564 |
| Prep. ex. 1 | 105.198 | 105.045 | 105.118 | 104.791 | 104.608 | 104.662 |
| Prep. ex. 2 | 105.198 | 105.153 | 105.104 | 104.992 | 104.875 | 104.75 |
| Prep. ex. 3 | 105.198 | 105.1 | 104.977 | 104.937 | 104.861 | 104.9 |
| Prep. ex. 5 | 105.198 | 105.372 | 105.364 | 105.17 | 105.18 | 105.07 |
| Prep. ex. 6 | 105.198 | 105.364 | 105.295 | 104.846 | 104.822 | 104.884 |
| Prep. ex. 7 | 105.198 | 105.466 | 105.184 | 104.984 | 104.74 | 104.755 |
| Prep. ex. 8 | 105.198 | 105.48 | 105.329 | 105.18 | 105.068 | 104.87 |
| Prep. ex. 9 | 105.198 | 105.203 | 105.103 | 105.03 | 105.001 | 104.814 |
| Comp. ex. 1 | 105.198 | 105.083 | 104.925 | 104.943 | 104.945 | 104.494 |

The loss of brightness at the highest addition level of Acid Violet 49 solutions is only in the range of 0.12% to 0.7% (Prep. ex. 5, Comp. ex. 1), in contrast to Direct Violet 35 showing a remarkable drop in brightness (Table 6). Best results are obtained with polyacrylamides described in Prep. examples 5, 8 and 9.

TABLE 7
AV 49; Lightfastness with increasing time of illumination in the presence
of CaCl₂

| | hours of exposure | | | | | |
|---|---|---|---|---|---|---|
| | 0 | 0.5 | 1 | 2 | 5 | 10 |
| DV 35 | 0 | −5.2 | −8 | −9.6 | −15.8 | −18.7 |
| Prep. ex. 2 | 0 | −3.7 | −6.9 | −8.5 | −13.5 | −17.7 |
| Prep. ex. 6 | 0 | −4.8 | −6.2 | −7.9 | −14.3 | −18.3 |
| Prep. ex. 9 | 0 | −3.8 | −5.6 | −7.7 | −13.6 | −15.6 |
| Comp. ex. 1 | 0 | −5.3 | −7.9 | −9.6 | −14 | −18.6 |

Paper shaded in the size press with Acid Violet 49 solutions containing different protective polymers synthesized according to the Preparative examples 2, 6 and 9 lead to similar or better light fastness than the Comparative example 1 without a protective polymer (Table 7). Best result is obtained with polyacrylamide described in Prep. example 9.

TABLE 8
AV 49; Lightfastness with increasing time of illumination without CaCl₂

| | hours of exposure | | | | | |
|---|---|---|---|---|---|---|
| | 0 | 0.5 | 1 | 2 | 5 | 10 |
| DV 35 | 0 | −4 | −6.4 | −9.5 | −11.8 | −15.9 |
| Prep. ex. 2 | 0 | −3.9 | −6.2 | −9.1 | −12.4 | −19.2 |
| Prep. ex. 7 | 0 | −1.7 | −5 | −7.7 | −11.2 | −17.6 |
| Prep. ex. 9 | 0 | −2 | −5.2 | −6.5 | −9.9 | −16.4 |
| Comp. ex. 1 | 0 | −5.3 | −8 | −10.8 | −14.2 | −19.5 |

Without CaCl₂ in the sizing composition the best light fastness is obtained with the polyacrylamide described in Prep. examples 9 (Table 8).

TABLE 9
AV 17; Development of whiteness with increasing amounts of dyestuff in
the presence of CaCl₂

| | Dye [g/l] | | | | | |
|---|---|---|---|---|---|---|
| | 0 | 0.005 | 0.01 | 0.015 | 0.02 | 0.03 |
| DV 35 | 135.55 | 136.48 | 138.21 | 140.4 | 141.3 | 143.27 |
| Prep. ex. | 135.55 | 139.41 | 141.3 | 144.88 | 146.88 | 149.2 |
| 16 | | | | | | |
| Prep. ex. | 135.55 | 139.54 | 141.92 | 143.54 | 145.93 | 149.14 |
| 17 | | | | | | |
| Prep. ex. | 135.55 | 140.5 | 142.02 | 144.19 | 146.55 | 150.1 |
| 18 | | | | | | |
| Prep. ex. | 135.55 | 139.97 | 142.57 | 144.36 | 146.15 | 149.95 |
| 19 | | | | | | |
| Prep. ex. | 135.55 | 140.43 | 141.38 | 144.21 | 145.79 | 149.88 |
| 20 | | | | | | |
| Comp. ex. 3 | 135.55 | 138.99 | 141.39 | 144.3 | 146.31 | 150.04 |

With solutions of Acid Violet 17 (with and without polymer) the whiteness degree is built up better than with Direct Violet 35 (Table 9). The whiteness degrees are similar than those achieved with Acid Violet 49 (Table 5).

TABLE 10
AV 17; Development of brightness with increasing amounts of dyestuff in
the presence of CaCl₂

| | Dye [g/l] | | | | | |
|---|---|---|---|---|---|---|
| | 0 | 0.005 | 0.01 | 0.015 | 0.02 | 0.03 |
| DV 35 | 105.809 | 105.173 | 105.049 | 104.788 | 104.315 | 103.633 |
| Prep. ex. | 105.809 | 106.535 | 106.537 | 106.748 | 106.682 | 106.306 |
| 16 | | | | | | |
| Prep. ex. | 105.809 | 106.539 | 106.498 | 106.365 | 106.462 | 106.238 |
| 17 | | | | | | |
| Prep. ex. | 105.809 | 107.023 | 106.492 | 106.54 | 106.625 | 106.355 |
| 18 | | | | | | |
| Prep. ex. | 105.809 | 106.71 | 106.768 | 106.561 | 106.499 | 106.329 |
| 19 | | | | | | |
| Prep. ex. | 105.809 | 106.786 | 106.41 | 106.585 | 106.466 | 106.478 |
| 20 | | | | | | |
| Comp. ex. 3 | 105.809 | 106.355 | 106.392 | 106.555 | 106.499 | 106.368 |

Even at highest addition level of Acid Violet 17 solutions (with and without polymer) the brightness is above the level of the base paper (without any dyestuff), in contrast to Direct Violet 35 showing a remarkable drop in brightness (Table 10). The results obtained with different polymers are very similar. The brightness degrees are similar than those obtained with Acid Violet 49 (Table 6).

TABLE 11
AV 17; Lightfastness with increasing time of illumination without CaCl₂

| | hours of exposure | | | | | |
|---|---|---|---|---|---|---|
| | 0 | 0.5 | 1 | 2 | 5 | 10 |
| DV 35 | 0 | −3.6 | −4.3 | −9.2 | −12.4 | −17 |
| Prep. ex. 17 | 0 | −3.2 | −4.9 | −9.5 | −13.9 | −18.9 |
| Prep. ex. 18 | 0 | −4.4 | −6 | −9.7 | −11.2 | −15.9 |
| Comp. ex. 3 | 0 | −4.3 | −6.2 | −10.8 | −13.6 | −18 |

The polyvinylalcohol described in the Prep. example 18 leads to a higher light fastness than it is obtained with the Comparative example 3 (Table 11).

TABLE 12
AV17; Development of whiteness with increasing amounts of dyestuff in
the presence of CaCl₂; without OBA

| | Dye [g/l] | | | | | |
|---|---|---|---|---|---|---|
| | 0 | 0.005 | 0.01 | 0.015 | 0.02 | 0.03 |
| DV 35 | 80.7 | 82.23 | 84.63 | 86.83 | 88.24 | 91 |
| Prep. ex. | 80.7 | 83.86 | 85.92 | 88.13 | 90.26 | 93.67 |
| 16 | | | | | | |
| Prep. ex. | 80.7 | 83.73 | 86.03 | 88 | 89.84 | 93.63 |
| 17 | | | | | | |
| Prep. ex. | 80.7 | 83.98 | 85.99 | 88.17 | 90.28 | 94.29 |
| 18 | | | | | | |
| Prep. ex. | 80.7 | 83.85 | 85.89 | 88.47 | 90.21 | 94.18 |
| 19 | | | | | | |
| Prep. ex. | 80.7 | 83.88 | 85.87 | 88.2 | 90.03 | 93.78 |
| 20 | | | | | | |
| Comp. ex. 3 | 80.7 | 83.77 | 86.06 | 88.37 | 90.3 | 94.1 |

Even without an optical brightener the whiteness degree is built up better than with Direct Violet 35 (Table 12).

TABLE 13
AV 17; Development of brightness with increasing amounts of dyestuff in
the presence of CaCl₂; without OBA

| | Dye [g/l] | | | | | |
|---|---|---|---|---|---|---|
| | 0 | 0.005 | 0.01 | 0.015 | 0.02 | 0.03 |
| DV 35 | 85.203 | 84.974 | 84.955 | 84.843 | 84.63 | 84.393 |
| Prep. ex. | 85.203 | 85.618 | 85.582 | 85.522 | 85.522 | 85.484 |
| 16 | | | | | | |
| Prep. ex. | 85.203 | 85.587 | 85.561 | 85.535 | 85.499 | 85.457 |
| 17 | | | | | | |
| Prep. ex. | 85.203 | 85.631 | 85.579 | 85.565 | 85.529 | 85.445 |
| 18 | | | | | | |
| Prep. ex. | 85.203 | 85.626 | 85.566 | 85.554 | 85.521 | 85.425 |
| 19 | | | | | | |
| Prep. ex. | 85.203 | 85.595 | 85.569 | 85.56 | 85.48 | 85.502 |
| 20 | | | | | | |
| Comp. ex. 3 | 85.203 | 85.626 | 85.63 | 85.61 | 85.512 | 85.436 |

When using AV 17 solutions even without an optical brightener the brightness is above the level of the base paper in contrast to Direct Violet 35 (Table 13).

1. A sizing composition comprising
(a) 0.0001 to 0.005% by weight of an acid dye of formula (1) 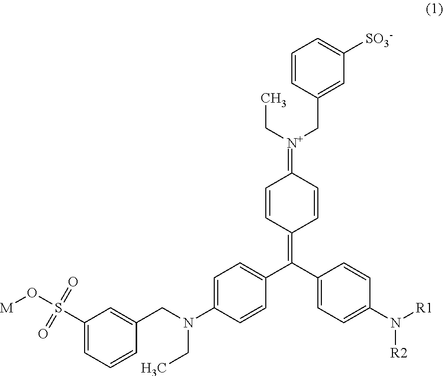
wherein
R¹ is H, methyl or ethyl,
R² is paramethoxyphenyl, methyl or ethyl,
M is an alkali metal kation
(b) between 0.000002 to 0.00225% by weight of at least one protective polymer selected from the group consisting of
(i) a polyvinyl alcohol or a carboxylic acid containing polyvinyl alcohol;
(ii) a homopolymer of acrylamide, acrylic acid or methacrylic acid;
(iii) a copolymer of acrylic acid or methacrylic acid with acrylamide or methacrylamide and
(iv) a polyethylene glycol;
(c) between 0.01 and 2% by weight of at least one optical brightener of formula (2); 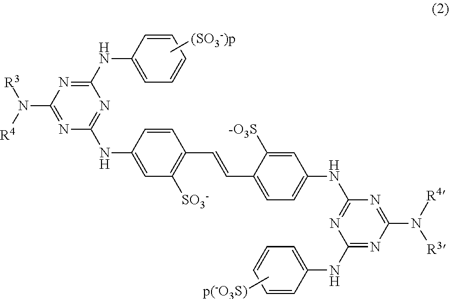
wherein
the anionic charge on the brightener is balanced by a cationic charge comprising one or more identical or different cations selected from the group consisting of hydrogen, an alkali metal cation, alkaline earth metal, ammonium, ammonium which is mono-, di- or trisubstituted by a C1-C4 linear or branched alkyl radical, ammonium which is mono-, di- or trisubstituted by a C1-C4 linear or branched hydroxyalkyl radical, and mixtures thereof,
R³ and R^{3′} are the same or different, and are hydrogen, C1-C4 linear or branched alkyl, C2-C4 linear or branched hydroxyalkyl, CH₂CO₂⁻, CH₂CH₂CONH₂ or CH₂CH₂CN,
R⁴ and R^{4′} may be are the same or different, and are C1-C4 linear or branched alkyl, C2-C4 linear or branched hydroxyalkyl, CH₂CO₂⁻, CH(CO₂⁻)CH₂CO₂⁻, CH(CO₂⁻)CH₂CH₂CO₂⁻, CH₂CH₂SO₃⁻, benzyl, or
R³ and R⁴ and/or R^{3′} and R^{4′}, together with the neighboring nitrogen atom form a morpholine ring and
p is 0, 1 or 2;
(d) between 1 and 30% by weight of at least one binder;
(e) optionally, between 0.1 and 10% by weight of at least one divalent metal salt;
(f) optionally a biozide; and
(g) the remainder up to 100% by weight water.

2. The sizing composition according to claim 1 wherein the at least one divalent metal salt is calcium chloride, magnesium chloride or mixtures thereof.

3. The sizing composition according to claim 1, further comprising an optical brightener of formula (3)

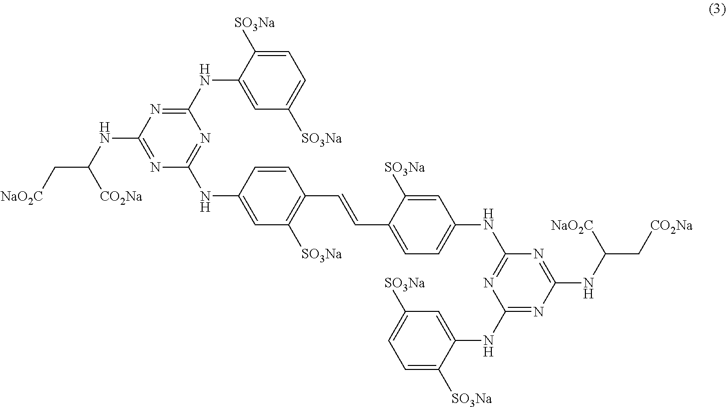

4. Thesizing according to claim 2, wherein the concentration of the at least one divalent metal salts salt in the sizing composition is in the range from 1 to 100 g/l.

5. The sizing composition according to claim 1, wherein the pH-value of the sizing composition is in the range from 5-10.

6. A paper sizing composition for use in a size press comprising the composition according to claim 1 including the components (a) and (b) and (c) and (d) and (e) and (f) and (g) is used to size paper in the size press.

7. A process for the production of sized paper in a size press comprising the step of sizing the paper with a sizing composition according to claim 1.

8. A sized paper made in accordance with the process of claim 8.
